(19) United States
(12) Patent Application Publication
(10) Pub. No.: US 2002/0078083 A1
(43) Pub. Date: Jun. 20, 2002

(54) Method and interface for assembling books

(75) Inventor: Mark A. Armstrong, Rochester, NY (US)

Correspondence Address: BRINKS HOFER GILSON & LIONE, P.O. Box 10395, Chicago, IL, 60610-0395, US

(73) Assignee: Heidelberg Digital L.L.C.

(21) Appl. No.: 10/000,704

(22) Filed: Oct. 31, 2001

Related U.S. Application Data
(60) Provisional application No. 60/245,072, filed on Nov. 1, 2000.

(51) Int. Cl. G06F 17/00

(52) U.S. Cl. 707/501.1

(57) ABSTRACT

An interface, implemented in a computer, for representing and controlling the electronic assembly of books or manuals. The interface comprises a display, a plurality of directories, each directory identifying a selected group of documents to be printed and a plurality of objects, each object being associated with a visual representation on the display of a plurality of different ordered stock media. The interface interacts with software that will open up a directory and perform a predetermined sorting of the ordered media contained in each of the directories. The software also preferably sorts the directories for each of the ordered media types. An operator can use the graphic user interface to move a selected directory to a predefined location on the screen whereby the software will perform the sorting function automatically.

This application claims the benefit of provisional application Ser. No. 60/245,072, entitled METHOD AND INTERFACE FOR ASSEMBLING BOOKS, filed on Nov. 1, 2000 under 35 U.S.C. 119(e).

A portion of the disclosure of the patent document contains material which is subject to copyright protection. The owner has no objection to the facsimile reproduction by any one of the patent disclosure, as it appears in the Patent and Trademark Office patent files or records, but otherwise reserves all copyright rights whatsoever.

### FIELD OF INVENTION

This invention relates to a method and document production system for managing the assembly of a document; and more particularly, a method and interface for assembling a book.

### BACKGROUND

While just about every computer user owns their own printer and is capable of producing high quality documents, the ability to produce such documents in high volume and with special finishing features, such as binding, is still within the purview of the commercial print shops and corporate copy departments. High volume, finished production of documents is typically referred to as production printing. A production printer is a printing device capable of rapid production of large volumes of documents. Typically these printers have high paper handling capacity, the ability to draw on multiple media types from multiple sources and the ability to automatically finish a document such as by adding a binding. Despite the automation provided by the production printer and the proliferation of computer technology, especially in the area of desktop publishing, production printing is still a complicated and often manual process.

In a typical print shop, customers bring in original documents which they want turned into a finished product such as a bound booklet, a book, a manual, a tri-fold brochure or a tabbed three ring bound notebook. In addition, they typically need a large volume of the finished product, for example, one thousand brochures. The combination of the original documents plus the instructions for producing the finished product is called a “job”. The documents can be brought in either in hard copy or electronic form, such as on floppy disk, compact disc or tape or can be transmitted to the print shop over a network such as the Internet.

After handing over the documents to the clerk, the customer relays his instructions for preparing the finished product. The clerk will note these instructions on a “ticket” or “job ticket”. The job ticket is typically a piece of paper with all of the instructions written on it for producing the finished product. As mentioned above, this is known as job. The job will then be handed to an operator, who runs the production printer, to produce the finished output. The operator's job is to prepare the document for production, load the appropriate materials, such as paper stock and binding materials, into the production printer and ensure that the finished output is correct.

While the job of the operator seems simple, there are many issues which quickly complicate it. Often, the documents provided by a customer are not ready to be run on the production printer. Some documents provided by a customer are merely raw manuscripts requiring basic formatting, such as margins, typography, etc. Other documents may be formatted but such formatting might not take into account the requested binding. For example, the text of the document is too close to the margin, therefore, when the finished product is bound, some of the text will be obscured. Some documents, such as books, require special care so that, for example, the first page of every chapter appears on the front of a page, also known as imposition. Other forms of imposition include booklet/pamphlet imposition or n-up imposition. Or the customer may bring in multiple documents and ask that these “chapters” be assembled into a book, with a cover and binding.

Other issues which complicate the production printing job are determining and loading the correct media into the production printer. Often, jobs will require many different paper types, such as different stock weights or different colors. In addition, some jobs require the insertion of tab stock at specific points within the document. Still other jobs may require the adding of a bates number or other annotation to the document.

With such a complicated production process to produce finished output, errors are bound to occur, such as loading the wrong paper stock in the printer or setting a margin too close to a binding. Production printers run at very high speeds, often producing output greater than 1 page per second therefore, errors in the finished output may not be caught before a significant amount of time and resources have been wasted.

Accordingly, there is a need for an efficient system and method for managing the production printing workflow.

### SUMMARY

The present invention is defined by the following claims, and nothing in this section should be taken as a limitation on those claims. By way of introduction, the preferred embodiments described below relate to an interface, implemented in a computer, for representing and controlling the electronic assembly of books or manuals. The interface comprises a display, a plurality of directories, each directory identifying a selected group of documents to be printed and a plurality of objects, each object being associated with a visual representation on the display of a plurality of different ordered stock media. The interface interacts with software that will open up a directory and perform a predetermined sorting of the ordered media contained in each of the directories. The software also preferably sorts the directories for each of the ordered media types. An operator can use the graphic user interface to move a selected directory to a predefined location on the screen where the software will perform the sorting function automatically. Presently, a method for creating a manual or book electronically on a display comprises separating each section or chapter of the manual or book into a directory.

### BRIEF DESCRIPTION OF THE DRAWINGS

FIG. 1 depicts a flow diagram illustrating a preferred production printing workflow.

FIG. 2 depicts a flow diagram showing the user functionality workflow of the preferred embodiment

### DETAILED DESCRIPTION OF THE PRESENTLY PREFERRED EMBODIMENTS

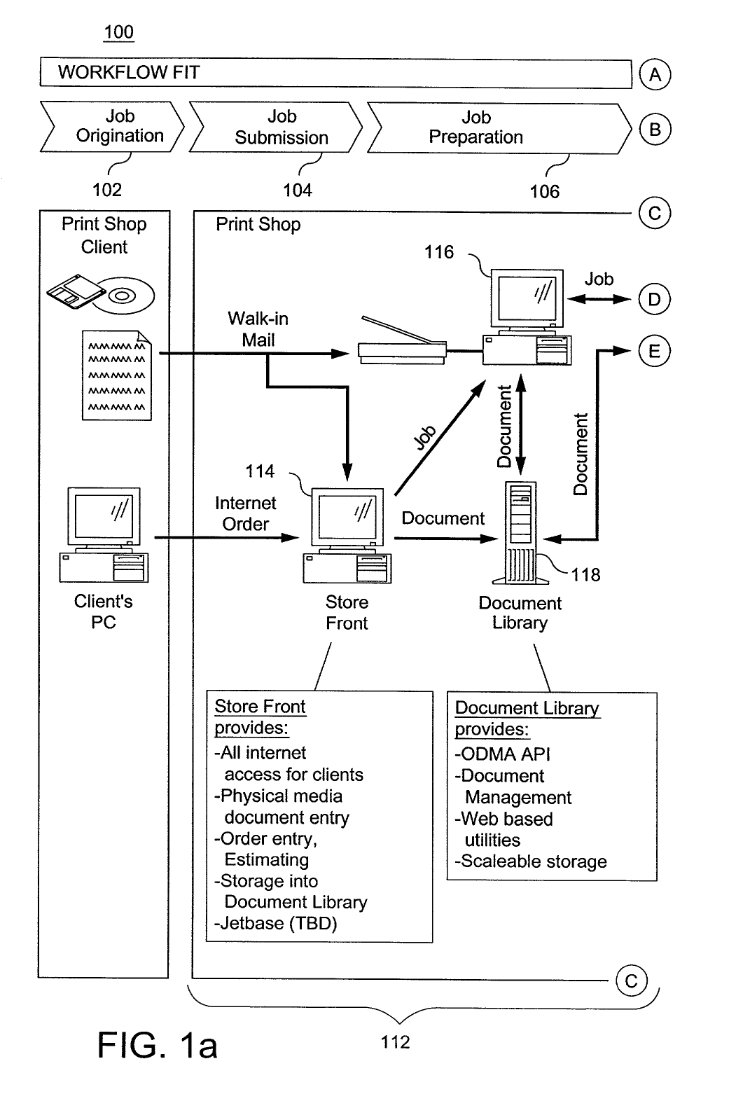

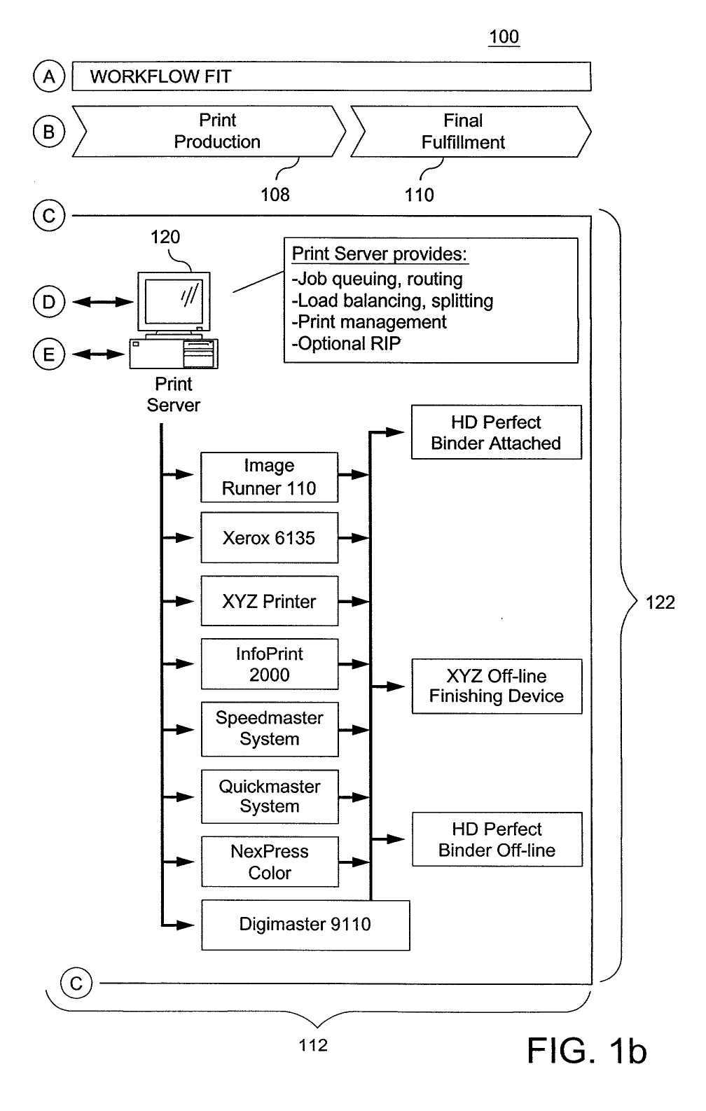

Referring now to FIG. 1, there is shown a flow diagram illustrating the production work flow 100 in a typical production print shop such as a commercial high volume copy or print shop. A workflow is defined as the tasks, procedural steps, organizations or people involved, required input and output information, and tools needed for each step in a business process. As will be discussed below, a workflow approach to analyzing and managing a business or process such as production printing can be combined with an object oriented approach, which tends to focus on the discrete objects and processes involved such as documents, pages, data and databases. For the purposes of this disclosure, the term “object oriented”, when applied to the disclosed embodiments, does not imply that an object oriented programming approach is the only method of implementation of the disclosed embodiments.

FIG. 1 further depicts a typical computer network 112 for use in a print shop. In a typical digital print shop, there will be a network 112 of computer work stations 114, 116, servers 118, 120 and high volume output devices 122 which make up the computer network 112. The servers 118, 120 include network servers 118 and print servers 120. The topology of the network 112 is typically structured so as to align with the workflow 100 of the print shop. The network 112 may be implemented as a wired or wireless Ethernet network or other form or local area network. Further the network 112 may include wired or wireless connections to wide area networks such as the Internet and connections to other local area networks such as through a virtual private network.

The production workflow 100 includes the procedural stages of job origination 102, job submission 104, job preparation 106, print production 108 and final fulfillment 110. Alternatively, one or more of these procedural stages may be combined as well as there may be other additional procedural stages. Job origination 102 is the procedural stage of receiving the documents and instructions, which together are defined as a “job”, from the customer. Job origination 102 can occur when a customer physically brings his job, whether in hard copy or electronic form, to the print shop or otherwise transmits the job to the print shop, whether by phone, fax, postal mail, electronic mail or over a local area or wide area network such as over the Internet. Note that a job may contain more than one document and more than one set of instructions. For example, a job may contain many documents, each being one chapter of a book, along with a document containing a cover for the book. This exemplary job may include the instructions for producing the body of the book from the individual chapter documents and another set of instructions for producing the cover. In addition, as will be discussed below, there may be a third set of instructions for assembling the cover to the body of the book.

Job submission 104 is the receipt of the job by the print shop and the entering of the job into the print shops production system or workflow. Typically the instructions from the customer will be written down on a special form, known as a “ticket” or “job ticket”. A ticket may also be electronically created and maintained. Furthermore, pre-defined tickets may be available for standardized instructions. For example, the shop may have a pad of pre-printed tickets with the instructions to duplicate the documents, three hole punch the final output and assemble the punched final output in a three ring binder. If this is a common request by customers, such pre-printed tickets can save time and resources. All the order taking clerk need do is fill in any customer specific details such as the number of copies to produce. Pre-defined tickets may help to standardize operations and prevent errors in the transcription of instructions from the customer. In very simple print shops, job submission 104 may simply be the receiving of the original documents and instructions along with the creation of a ticket, placing the job in a paper folder and setting it in a physical queue for later handling in subsequent procedural stages.

In print shops which handle jobs electronically, job submission 104 requires entering the job into the shops electronic production system. For documents which are brought in by the customer as hard copy, the documents must first be scanned electronically into the shop's computer system. For documents delivered in electronic form, the document data files must be loaded on the shop's computer system.

For the job submission stage 104, the computer network 112 will include one or more “store front” workstations 114. The store front workstations 114 are computer systems placed at the order taking desk, at a manned clerk's station or set out for customer self service use. These workstations 114 are used for the job submission stage 104 and typically will be configured to handle many different electronic media types such as floppy disk, compact disc, tape, etc. These stations 114 may also be configured to receive jobs over the Internet or other form of network connection with customers. Further, these workstations 114 are typically configured to read many different electronic file formats such as those used by the Microsoft Office™ family of products manufactured by Microsoft Corporation, located in Redmond, Washington or various other desktop publishing program file formats such as Aldus Pagemaker™ or QuarkXpress™. In addition, these stations 114 can also read “ready for printer” file formats, which will be discussed later, such as Portable Document Format™ (“PDF”), Postscript™ (“PS”) or printer control language (“PCL”). Job preparation stations 114 can also accept image formats such as Tagged Image File Format (“TIFF”), bitmap (“BMP”) and PCX. These stations 114 may also include a scanner 116 for scanning hard copies of documents into the computer system. Scanners typically are complicated devices to operate and some print shops may prefer to locate the scanners in the job preparation stage 106 for use solely by trained personnel as will be discussed below. In addition, the store front computers 114 also provide the ability to generate a ticket, electronically or in hard copy form, for the job containing all of the instructions for completing the production printing task. This process of generating the ticket may be automated, involving pre-defined tickets, manual or a combination thereof, and is discussed in more detail below.

Job preparation 106 involves preparing the documents for printing according to the instructions in the ticket. For documents that are submitted in hard copy form, job preparation 106 may include scanning the documents and creating a faithful and error free electronic reproduction. The documents, once in electronic form, must also be distilled down or converted into a common file format that the print shop can use to both edit and print the documents. This alleviates the need for operators to deal with multiple different programs and eliminates the need to assemble complex documents together for printing using different electronic file formats.

For example, a customer may bring in two different documents, one being the body of a book and the other being the photographs to be inserted at specific pages. The customer may then instruct that the photographs be inserted at particular pages and that the final assembly have continuous page numbers added. The body of the book may be in Microsoft Word™ format while the images of the photographs are in Adobe Photoshop™ format. While the operator could figure out at which pages the images will be inserted and appropriately number the pages of the book and photographs using each individual software package, this is a very complex and time consuming process. It also requires that the operator be trained and familiar with a range of software packages and runs the risk that he will not be familiar with the particular package that the customer used. Therefore, it is more efficient to distill each of the various file formats into a unified format which allows the operator to prepare the job using a single software interface. In the preferred embodiments, all documents, whether provided in hard copy or electronically, are distilled or converted into a “ready for printer” or “print ready” file format. In the preferred embodiments, the Portable Document Format™ is used as the ready for printer format, developed by Adobe Systems, Inc., located in San Jose, Calif.

A ready for printer file format is defined as a file format which contains both the data to be printed along with printer control instructions that can be directly interpreted by the internal processing engine of a printer or other form of hard copy output device in order to rasterize the data image onto the output media. Rasterization is the placement of image data at a specific location on the output media. Such file formats include Portable Document Format™ (“PDF”) and Postscript™ (“PS”) both manufactured by Adobe Systems, Inc., located in San Jose, Calif., as well as printer control language (“PCL”), manufactured by Hewlett Packard, located in Palo Alto, Calif. Examples of non-ready for printer formats include the native application file formats for personal computer application programs such as Microsoft Word™. These file formats must be first converted to a ready for printer file format before they can be printed. Furthermore, some image file formats, such as the Tagged Image File Format (“TIFF”) contain bit image data only which is already in a format which specifies its output location on the output media and does not contain printer control instructions for interpretation by the internal processing engine of the printer and therefore, for the purposes of this disclosure, is not a ready for printer file format. By using a ready for printer format, rasterization of the image data can be delayed as close as possible to the final placement of the image data on the output media. This allows the most efficient use of the production print device 122 by allowing its internal control logic to optimize the rasterization process resulting in output that is more likely to match with the operator's expectations.

For the job preparation stage 106, the computer network 112 includes job preparation stations 116 and network servers 118 coupled with the store front workstations 114 over the network 112. Herein, the phrase “coupled with” is defined to mean directly connected to or indirectly connected with through one or more intermediate components. Such intermediate components may include both hardware and software based components. The job preparation stations 116 preferably execute workflow management software, described in more detail below, which allows the operator to manage, edit and print jobs. The network server(s) 118 includes a document library which allows manipulation, management, storage and archiving of jobs, or just their respective documents and/or tickets, as well as facilitates and manages the flow of jobs from the store front computers 114 to the job preparation stations 116 and from the job preparation stations 116 to the print servers 120 or the production output devices 122. Exemplary document libraries include Intra.Doc™ document management system manufactured by Intranet Solutions, Inc., located in Eden Prairie, Minn. and the DOCFusion document management system manufactured by Hummingbird, Inc., located in York, Ontario, Canada. In the preferred embodiment, the job preparation stations 116 are Imagesmart™ Workstations, manufactured by Heidelberg Digital, L.L.C., located in Rochester, N.Y. Alternatively, an appropriate computer hardware platform such as that comprising a Pentium™ class processor or better, manufactured by Intel Corporation, located in Santa Clara, Calif., 64 megabytes of RAM or more, a 20 gigabyte hard disk or larger and appropriate display device may be used. Further, in the preferred embodiment, the network servers 118 preferably comply with the Open Document Management Architecture (“ODMA”) standard and provide document management capabilities and scaleable storage.

The job preparation workstations 116 also provide the capability of the print shop to add value to the print production process by offering services to the customer. Such services include the ability to modify documents provided by the customer to add features that the customer could not or would not add himself. Such features include adding page numbers across multiple documents, bates numbering, adjusting page layout for tab stock and aligning the output to account for binding. Further the job preparation stations 114 provide the capability to fix errors in the documents such as removing artifacts in scanned images and masking over unwanted text or markings. The job preparation stations 114 can also be used to prevent inaccuracies in the finished output caused by the printing or binding process. Such inaccuracies include binder's creep which happens after a document is imposed into a booklet/pamphlet using a signature imposition. Binder's creep occurs when the placement of the images on the paper fails to account for the thickness of the binding as a function of the number of pages in the book causing the image on the pages to shift inward as you get closer to the cover. Binder's creep is prevented by shifting image slightly when performing the signature imposition on the document. In addition, the job preparation station 116 allows the operator to manage and layout the document pages for final output, also known as “imposition” and “signature imposition”. In addition, the operator can shuffle pages, reverse pages, insert blank pages, trim and shift pages, create bleeds and place multiple pages on a sheet, also known as “n-up” to create proof sets, brochures or pamphlets, etc. Further the job preparation station 116 permits the operator to add annotations to the document such as bates numbers, page numbers, logos and watermarks. All of these service add value to the final output. Formatting and other modifications to the document can be globally applied to the entire document, such as a shifted margin or may be applied only to select pages. Such alterations to the document are known as document/page features or attributes. Further, these alterations are also known as document or page exceptions since they typically override specific instances of the original document formatting as set by the customer.

The next stage in the print production workflow 100 is the print production stage 108. In the print production stage 108, the final form of the documents for printing is sent to a print server 120 which will distribute the job to the final output device 122. In manual print shops, this stage 108 would be similar to an operator manually taking the ready for production job over to the desired output device 122 to start the job. The print production stage 108 manages the output resources of the print shop. Such management includes queuing jobs to the proper devices 122 in the shop, routing jobs to available devices 122, balancing the load placed on the various devices 122, and pre-processing jobs, such as splitting or RIP'ing the job, prior to sending it to a particular device 122. RIP stands for Raster Image Processor and is the hardware and/or software which converts ready for printer data into raster images. It is also a common term for rasterizing a page image on to the output media.

The print server 120 used in the print production stage 108 is coupled with the job preparation stations 116 and the network server 118 over the network 112. Further, the print server 120 is coupled with the various output devices 122 in the print shop. Note that some output devices 122 may not support electronic transfer of the data to be output and may require a manual step for operation. Such devices may include a special binding machine which requires that the partially finished documents be manually transferred to the binding machine to complete the production. The print server 120 is preferably implemented as a separate computer coupled with the network 112, however, software based print servers running on a network server 118, job preparation station 116 or store front workstation 114 may also be used. In the preferred embodiment, the printer server 120 includes an independent computer workstation, typically running a UNIX or Windows NT operating system, a software print server engine and a software print server application. The print server application offers the user interface ability to configure and manage the print server operation. The print server engine performs the automated processes of the print server. These processes include spooling and queuing jobs and job content (i.e. the document), directing the jobs to specific production output devices based on the attributes of the print job and how these attributes are satisfied by the print engine, load balancing jobs among the various production output devices to keep all printers fully utilized, e.g. to split color from black and white jobs, and acting as a communication gateway where it can accept multiple input communication and print protocols translating them to the communication and print protocol the production output device 122 understands.

The final stage of the production printing workflow 100 is the final fulfillment stage 110. The final fulfillment stage 110 is the stage where the finished output is produced on the production output device 122. A production output device is a computer output device, such as a printer, designed for high volume production of printed documents. Such devices preferably include the ability to produce large quantities of documents with mixed media types and various degrees of finishing, such as stapling or binding, at very high speed. Exemplary output devices include the Digimaster™ Digital High Volume Printer manufactured by Heidelberg Digital, L.L.C., located in Rochester, N.Y.

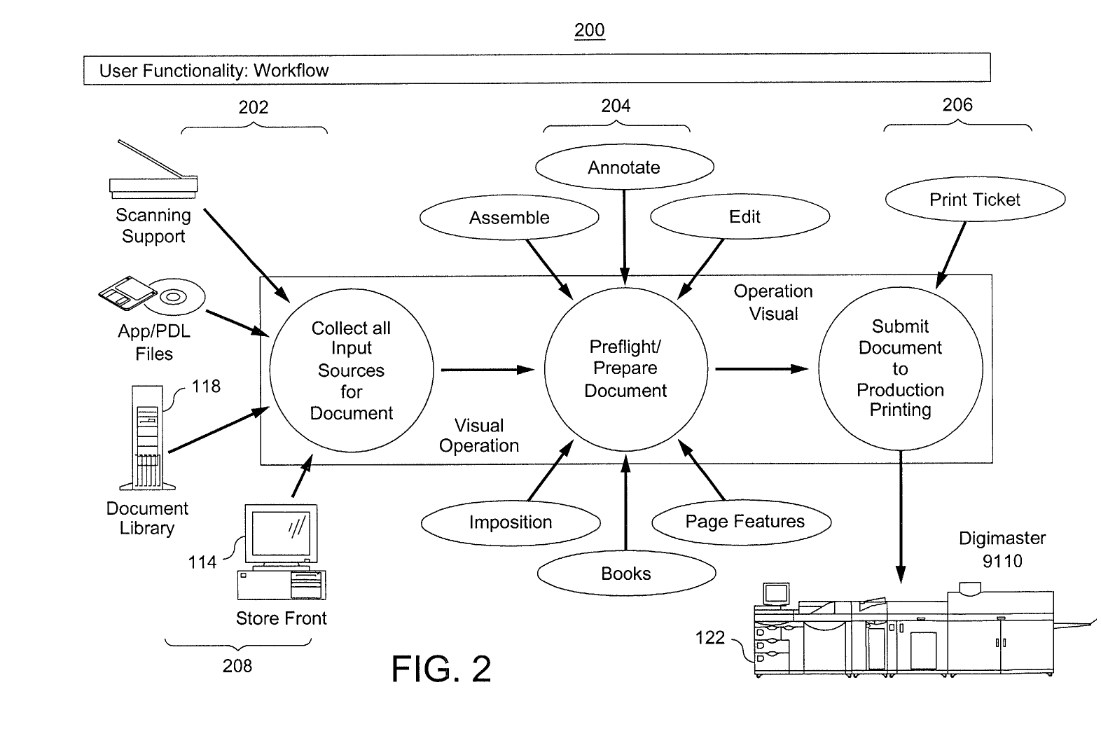

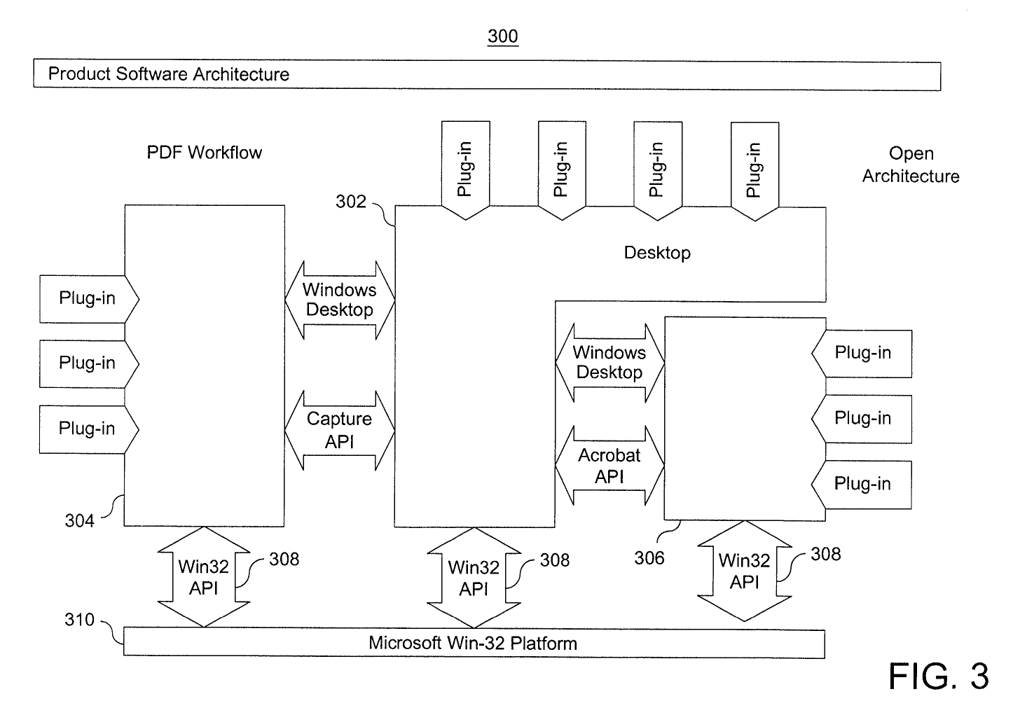

Referring now to FIG. 2, there is shown a flow diagram showing the user functionality workflow 200 of the preferred embodiment job submission and preparation stages 104, 106. The user workflow 200 includes an input source stage 202, a preflight stage 204 and a production stage 206. In the input source stage 202, all of the documents of the job are collected together from the different input sources 208. As detailed above, all of the collected documents are converted to a ready for printer format, preferably a Portable Document Format™. This conversion can be a manual or automated process or a combination thereof. For example, a special directory can be created on the network server 118 where data files in various file formats can be placed, for example, by the clerk who accepts the documents from the customer and inputs them into the store front workstation 114. Automated logic which watches this directory, will see the placement of files and automatically convert them (or flag them for manual conversion) into a ready for printer format. Any documents which the automated logic cannot handle can be flagged for manual conversion. The converted documents are then passed to preflight stage 204 where they are prepared for production. This transfer of converted documents can occur by moving the documents to a special directory on the network server 118 where they can be accessed by the job preparation stations 116 or by transmitting the documents to the job preparation station 116. This process can be manual or automated and may involve placing the documents in a queue of documents waiting to be prepared for production. Further, this process may include a manual or automated determination of the capabilities, skill level or training level of the various operators currently logged into the available job preparation stations 116 as well as the current load/backlog of job in their respective queues. Taking these factors into account, job can be automatically or manually routed to the operator best able to handle the job both technically and in an expedient manner. This functionality can be implemented by creating an operator database which tracks the capabilities, skill level and training level of the various operators who work in the print shop. This database can be coupled with queue management software which balances the loads/backlogs of job at each station 116.

In the preflight stage 204, the documents can be assembled, such as in a book, annotated, edited, and have imposition or other page features applied. Once the documents are prepared for production, they are passed to the production stage 206. In the production stage 206, the prepared documents along with the production instructions (from the tickets) are submitted to the print server or directly to the production output device 122 using a file downloader such as the Print File Downloader™ application program manufactured by Heidelberg Digital, L.L.C., located in Rochester, N.Y. This user functionality workflow 116 may be implemented as a combination of hardware, software and manually executed components and may involve one or more of the components detailed in the production printing workflow above.

The chapters or sections of a book or manual may each contain different ordered media such as a cover, a table, a document indicating the start of a chapter or various tabs. Commonly, the chapter or subsection will be shown on a display in the directory with different objects representing each ordered media such as tabs contained in the chapter. Under present systems, the operator can first manually assemble all of the parts of one chapter and then assemble all of the parts of each succeeding chapters. The present system permits a directory which contains sections or chapters to be added to the document to be printed in one operation. This is accomplished by providing a graphic user interface (GUI) which displays the chapters of a document, including the ordered media for each chapter, such as tabs, covers, tables, or a page indicating the start of a chapter. The operator uses any suitable means, such as mouse, or other pointing device to drag the directory on the display to a preselected location on the screen which indicates that the item dragged to that location must be added to the document to be printed and assembled electronically. When the directory is dragged to the location and added to the document to be printed, software will open up the directory and perform an alpha-numeric sort of the contents. The software will first sort out the documents and add them to a list in memory. The documents will be added preferably to the list in memory in the following order: documents starting with “tabs”; documents starting with “cover”; documents starting with “table”; and, finally documents starting with “chapter.”

Next, the software will take the sorted directories and perform the same sorting logic described above on the directories. That is, the software will perform the above functions recursively. The result is that the contents which have been added to the list are sorted and the documents are added to the list using the above logic. The sorted directories are then examined by the operator to assure that the document is indeed assembled correctly. Thus, by simply using a dragging operation of all of the directories which are to be part of the document to be printed, the system automatically sorts and creates the book or manual using one operation. A preferred embodiment of code showing the software for performing the sorting is attached hereto as Appendix A.

In another preferred embodiment of the invention, the software will also count the number of times a document, such as a tab is used. This count is used to create a file name. For example, if tab PS is used seven times, a file name “tab 7.PS” is created. The software will then search a specific location for the file name “tab 7.PS”. If this file exists, the file is then added to the list. This feature may be particularly useful for using ordered stock, such as tabs. For example, tabs commonly come in predefined sets such as sets of five, seven, etc. A chapter in a book may not use all of the tabs in a set. Thus, it may be necessary to delete or identify some of the tabs from the set before the next copy of the document or chapter is printed. For example, if a chapter only uses three tabs and the tabs come in sets of five, it may be necessary to purge tabs 4 and 5 from the drawer containing the tab stock. Using this feature of the invention, the file name can be used to determine how many tabs are used in the chapter. If the number of tabs in the predefined set is identified to the computer, the program can use the file name, which indicates the number of tabs actually used in the particular chapter, and the number of tabs in the predefined set to know how many tabs must be purged. One manner of implementing the purging is to use the “SHOWPAGE” command using Abode Postscript™. This command will instruct the machine to take the next page in a designated paper supply drawer, here the drawer containing the tabs, and feed that sheet to the top exit.

The foregoing description of the system and method describe several illustrated examples of the invention. Modifications, alternative arrangements, and variations of these illustrated examples are possible and may fall within the scope of the invention. Accordingly, the following claims should be accorded the reasonably broadest interpretation which is consistent with the specification disclosed herein and not unduly limited by aspects of the preferred embodiments disclosed herein.

void add_directory(DIR_INFO *dir_info)
{
DIR *dp1, *dp2;
struct dirent *manual;
char section_path[1024];
char chap_path[1024];
DIR_INFO *new_dir_info;

new_dir_info = (DIR_INFO *) malloc(sizeof(DIR_INFO));

new_dir_info−>tab_cnt = 0;

printf ( “Adding directory %s\n”, dir_info−>filename);
dpl = opendir( dir_info−>filename);
if(dp1 == NULL)
{

return;

}

/* add tabds */

for(manual = readdir(dp1); manual != NULL; manual = readdir(dp1))

{

if(‘.’ == manual−>d_name[0])
{

continue;

}

sprintf(section_path, “%s/%s”, dir_info−>filename, manual−>d_nam
dp2 = opendir(section_path);

if(dp2 == NULL)
{

if(strncmp(manual−>d_name, “tab”, strlen(“tab”)) == 0)
{

printf(“ adding Tab\n”);

/* add tab name */

strncpy(dir_info−>tab_name, manual−>d_name, 4);
dir_info−>tab_name[4] = ‘\0’;
add_file(section_path, PANEL_CLEAR, 24, NULL);
dir_info−>tab cnt++;

}

}

}

rewinddir(dp1);

/* add body documents or covers */

for(manual = readdir(dp1); manual != NULL; manual = readdir(dp1))
{

if(‘.’ == manual−>d_name[0])
{

continue;

}
sprintf(section_path, “%s/%s”, dir_info−>filename, manual−>d_nam
dp2 = opendir(section_path);
if(dp2 == NULL)
{

/* add any cover file, etc. No tab files at this point */

if(strncmp(manual−>d_name “tab”, strlen(“tab”)) != 0)

{

printf(“ Adding %s\n”, section_path);
add_gfm_f ile (section_path);

}

}

}
rewinddir (dp1);
for (manual = readdir (dp1); manual != NULL; manual = readdir (dp1))
{

if(‘.’ == manual−>d_name[0])
{

continue;

}
sprintf (new_dir_info−>filename, “%s/%s”, dir_info−>filename, man
dp2 = opendir (new_dir_info−>filename) ;
if (dp2 != NULL)
{

add_directory(new_dir_info);
closedir (dp2);

}

}

printf(“Tab count is %i\n”, new_dir_info−>tab_cnt) ;

if (new_dir_info−>tab_cnt != 0)
{

sprintf (chap_path, “%s/%s-%i.ps”, TAB_FILES, new_dir_info−>tab_n
add_file ( chap_path, PANEL_CLEAR, 24, NULL);

}
free(new_dir_info);
return;

}
/* DHV change, for BlueCross, add a whole manual at one time */
add_drop_manual(GDD_DROP_INFO *di)
{
DIR *dp1;
char new_tab_name[100];
int new_tab_cnt;
char chap_path[1024];
DIR_INFO *new_dir_info;

dp1 = opendir ( di−>filename);
if(dp1 == NULL)
{

notice(“Only directories may be drop”);
return;

}

closedir (dp1);

new_dir_info = (DIR_INFO *) malloc (sizeof (DIR_INFO) );
new_dir_info−>tab_cnt = 0;
strcpy(new_dir_info−>filename, di−>filename);

printf(“Adding Manual\n”);
add_directory(new_dir_info);

printf(“Tab count is %i\n”, new_dir_info−>tab_cnt);

if(new_dir_info−>tab_cnt > 0)
{

sprintf(chap_path, “%s/%s-%i.ps”, TAB_FILES, new_dir_info−>tab_name, new_d
add_file(chap_path, PANEL_CLEAR, 24, NULL);

}

free (new dir info);

}

I claim:

1. A document production system for managing the assembly of a document, the system comprising:
a display for displaying a visual representation;
a data storage device for storing a directory for identifying a corresponding selected group of documents to be printed;
a plurality of data objects being associated with corresponding visual representations on the display, at least one object representing a set of ordered media for document production; and
software instructions for accessing the directory and performing a predetermined arrangement of the ordered media for the documents contained in the directory.

2. The system according to claim 1 further comprising:
a graphical user interface for moving a selected directory to a predefined location on the screen of the display to trigger the performance of the predetermined arrangement.

3. The system according to claim 1 further comprising:
a graphical user interface for dividing a document into sections for placement into corresponding directories.

4. The system according to claim 1 further comprising:
a user interface for separating each chapter of a book, as the document, for placement into a corresponding directory.

5. A method for managing the assembly of a document for a document production system, the method comprising:
establishing a plurality of directories, each directory identifying a selected group of documents;
establishing a plurality of objects, each object being associated with a visual representation on a display, at least one object representing a set of ordered media; and
accessing the directories and performing a predetermined arrangement of the ordered media contained in the directories.

6. The method according to claim 5 wherein the performing of the predetermined arrangement comprises sorting of the ordered media.

7. The method according to claim 5 further comprising:
moving a selected one of the directories to a predefined location on a screen of the display to trigger the performance of the predetermined arrangement.

8. The method according to claim 5 further comprising:
separating each section of a document for placement into corresponding directories.

9. The method according to claim 5 further comprising:
separating each chapter of a book, as the document, for placement into a corresponding directories.

10. A method for managing document production, the method comprising:
inputting input data in a raw document format into a document production system;
converting the inputted data from the raw document format into a ready-for-printer format, the converting triggered by placement of the files into a conversion directory;
placing the converted documents in a job preparation directory; and assembling the converted documents in a document assembly of one or more prepared documents.

11. The method according to claim 10 further comprising: submitting the prepared documents for processing by an output production device.

12. The method according to claim 10 wherein the assembling comprises one or more of the following: annotating at least one of the converted documents, editing at least one of the converted documents, imposition of at least one of the converted documents, and applying a page feature to at least one of the converted documents.

13. The method according to claim 10 comprising:
determining at least one of the capabilities, skill levels, and training levels of corresponding operators of the document production system;
storing data in a database on at least one of the determined capabilities, skill levels, and training levels of the operators; and
allocating a print job of converted documents to a corresponding operator for handling the print job based on at least one of the determined capabilities, skill levels, and training levels of the operators.

14. The method according to claim 10 wherein the placing comprises placing the converted documents into a queue waiting for the assemblying and production by the document production system.

15. The method according to claim 10 wherein each prepared document comprises at least one of a chapter of a book, a cover for a book, instructions for printing the chapter, and instructions for printing the cover.

16. The method according to claim 10 wherein each prepared document comprises at least one of a section of a written work, a cover for a written work, instructions for printing the section, and instructions for printing the cover.

17. The method according to claim 10 wherein each of said prepared documents contains a ready-for-printer format comprising data for printing and control instructions.

18. The method according to claim 10 wherein the ready-for-printer format comprises at least one of a portable document format, a postscript format, and a printer control language.

19. The method according to claim 10 wherein the assemblying comprises modifying the converted document by adding page numbers across multiple converted documents to form the document assembly.

20. The method according to claim 10 wherein the assemblying comprises adjusting page layout for tab stock to form the document assembly.

21. The method according to claim 10 wherein the assemblying comprises aligning binding of the prepared documents to compensate for binding alignment.

22. The method according to claim 10 wherein the prepared documents comprise one or more of the following: chapters of a book, sections of a book, chapters of a manual, sections of a manual, instructions on ordered media, a cover, a table, a document indicating the start of a chapter, a document indicating the placement of a chapter, and a document indicating placement of various tabs.

23. The method according to claim 10 further comprising displaying a section on a display in the directory with different objects representing each ordered media contained in the section.

24. The method according to claim 10 further comprising displaying chapters of a converted document and displaying ordered media for each chapter.

25. The method according to claim 24 wherein the ordered media includes at least one of tabs, a cover, tables, or a page indicating the start of a chapter.

26. The method according to claim 10 wherein the assemblying comprises dragging a directory on the display to a preselected location of the display to add the converted document to the document assembly.
